(19) United States
(12) Patent Application Publication
(10) Pub. No.: US 2011/0295723 A1
(43) Pub. Date: Dec. 1, 2011

(54) ADVERTISEMENT INVENTORY MANAGEMENT

(75) Inventors: Eswar Priyadarshan, West Roxbury, MA (US); Dan Marius Grigorovici, Pleasanton, CA (US); Ravikiran Chittari, Acton, MA (US); Omar Abdala, Cambridge, MA (US); Hao Duong, Castro Valley, CA (US)

(73) Assignee: Apple Inc., Cupertino, CA (US)

(21) Appl. No.: 12/790,486

(22) Filed: May 28, 2010

(51) Int. Cl. G06Q 10/00

(52) U.S. Cl. 705/28

(57) ABSTRACT

Systems and methods are provided for automating booking and pricing of inventory atoms are provided, where each atom defines a granular traffic target in a k-dimensional booking space. In operation, a content delivery system receives a request for an inventory slot, consisting of at least some segment characteristics and a cost objective. In response to this request, the content delivery system retrieves availability for each atom in the target inventory slot from an inventory atom database. Additionally, a pricing for each atom in the request inventory slot is also obtained. Thereafter, the content delivery system will assemble a proposed inventory slot for the advertiser that includes the atoms that meet the advertiser's cost objective and the total cost for the proposed inventory slot. If accepted, the atom inventory database can be updated to reflect the new unavailability of the atoms in the proposed database.

### FIELD

The following relates to advertisement inventory and more specifically relates to systems and methods for managing advertisement inventory.

### BACKGROUND

Computer applications, websites, or other electronic content including offers for products and services generally require a user to explicitly select and/or interact with one or more portions of the content being presented to generate a conversion (e.g., completion of a sale or purchase, submission of information to a content provider, causing delivery of additional information to the user or any other pre-defined response for the content). For example, an advertisement for a product or service can require the user to select the advertisement and navigate to the online store offering the product for sale. At the online store, the user can then enter information to purchase or obtain additional information regarding the product or service.

In many types of electronic content maintained by content providers, the portions of the content offering products and services are generally not static. Rather, such (primary) content providers may offer such portions, directly or via an agent, for use by one or more other (secondary) content providers. Thus, the content in these portions will typically vary over time, depending on the arrangement between the primary and secondary content providers. As a result, primary content providers (or their agent) are generally faced with a non-trivial task of managing sale and use of these content portions for secondary content providers. Accordingly, such content providers assign the task of managing the secondary content providers to an agent that assembles can combines content from many primary and secondary content providers.

### SUMMARY

Accordingly, the present technology provides systems and methods for managing electronic content from multiple content providers. More specifically, the present technology provides systems and method for managing electronic content in an environment where traffic changes dynamically. In particular, systems and methods are provided for automating booking and pricing of inventory atoms, where each atom defines a granular traffic target in an inventory space or region in a k-dimensional space, where each of the k dimensions is associated with one of a plurality of traffic segment characteristics.

In operation, a content delivery system receives a request for an inventory slot, consisting of at least some segment characteristics and a cost objective. In response to this request, the content delivery system retrieves availability for each atom in the target inventory slot from an inventory atom database. Additionally, a pricing for each atom in the request inventory slot is also obtained. Thereafter, the content delivery system will assemble a proposed inventory slot for the advertiser that includes the atoms that meet the advertiser's cost objective and the total cost for the proposed inventory slot. If accepted, the atom inventory database can be updated to reflect the new unavailability of the atoms in the proposed database. In some cases, the atoms in the proposed inventory slot can be temporarily configured as being unavailable until an acceptance or rejection is received.

In some instances, a target inventory slot can intersect an existing inventory slot of atoms already booked to another advertiser. Thus, the present technology also allows for managing such conflicts. In particular, in response to the occurrence of such an intersection, the present technology can provide alternate inventory atoms for the target inventory slot. That is, requests for inventory atoms can specify a range of alternatives that are acceptable to the advertiser and alternate atoms can be selected based this criterion. In other cases, the criteria specified for each of the target inventory slot and the booked inventory slot are used to adjust the atoms in one or both of the slots to remove the intersection. In the various cases described above, the present technology can also provide an alternate pricing for these alternate inventory atoms or for other atoms in the proposed inventory slot.

The pricing of the atoms can be provided in several ways. For example, some atoms can be associated with a fixed cost. Alternatively, a cost for some atoms can be projected by evaluating a past demand for the atoms by advertisers. Additionally, a cost for some atoms can be a base cost that is subsequently adjusted according to one or more atom-specific factors. Further, any combination of these methods can also be used.

### BRIEF DESCRIPTION OF THE DRAWINGS

FIG. 1 illustrates an example computing device;

FIG. 2 illustrates an example system embodiment;

FIG. 3 is a schematic diagram of a inventory space;

FIG. 4 is a flowchart of steps in an exemplary method 400 for managing inventory atoms;

FIG. 5 is a schematic of a exemplary process for estimating future demand and cost for an atom(s) of interest; and

FIG. 6 is a schematic diagram showing possible conflicts or intersections between proposed and booked inventory slots.

FIG. 7 is a flowchart of steps in an exemplary method for removing conflicts or intersections of overlapping slots.

### DESCRIPTION

Various embodiments of the disclosed methods and arrangements are discussed in detail below. While specific implementations are discussed, it should be understood that this is done for illustration purposes only. A person skilled in the relevant art will recognize that other components, configurations, and steps may be used without parting from the spirit and scope of the disclosure.

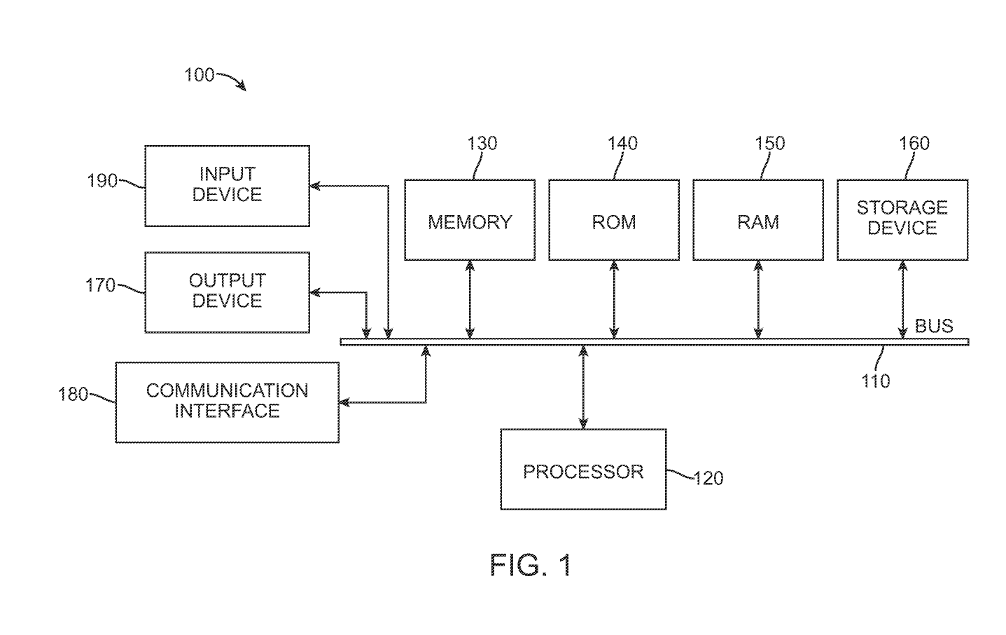

With reference to FIG. 1, a general-purpose computing device 100 which can be portable or stationary is shown, including a processing unit (CPU) 120 and a system bus 110 that couples various system components including the system memory such as read only memory (ROM) 140 and random access memory (RAM) 150 to the processing unit 120. Other system memory 130 may be available for use as well. It can be appreciated that the system may operate on a computing device with more than one CPU 120 or on a group or cluster of computing devices networked together to provide greater processing capability. The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices such as a hard disk drive 160, a magnetic disk drive, an optical disk drive, tape drive or the like. The storage device 160 is connected to the system bus 110 by a drive interface. The drives and the associated computer readable media provide nonvolatile storage of computer readable instructions, data structures, program modules and other data for the computing device 100. In one aspect, a hardware module that performs a particular function includes the software component stored in a tangible computer-readable medium in connection with the necessary hardware components, such as the CPU, bus, display, and so forth, to carry out the function. The basic components are known to those of skill in the art and appropriate variations are contemplated depending on the type of device, such as whether the device is a small, handheld computing device, a desktop computer, or a large computer server.

Although the exemplary environment described herein employs a hard disk, it should be appreciated by those skilled in the art that other types of computer readable media which can store data that is accessible by a computer, such as magnetic cassettes, flash memory cards, digital versatile disks, cartridges, random access memories (RAMs), read only memory (ROM), a cable or wireless signal containing a bit stream and the like, may also be used in the exemplary operating environment.

To enable user interaction with the computing device 100, an input device 190 represents any number of input mechanisms, such as a microphone for speech, a touch-sensitive screen for gesture or graphical input, keyboard, mouse, motion input, speech and so forth. The device output 170 can also be one or more of a number of output mechanisms known to those of skill in the art. For example, video output or audio output devices which can be connected to or can include displays or speakers are common. Additionally, the video output and audio output devices can also include specialized processors for enhanced performance of these specialized functions. In some instances, multimodal systems enable a user to provide multiple types of input to communicate with the computing device 100. The communications interface 180 generally governs and manages the user input and system output. There is no restriction on the disclosed methods and devices operating on any particular hardware arrangement and therefore the basic features may easily be substituted for improved hardware or firmware arrangements as they are developed. For clarity of explanation, the illustrative system embodiment is presented as including individual functional blocks (including functional blocks labeled as a “processor”). The functions these blocks represent may be provided through the use of either shared or dedicated hardware, including, but not limited to, hardware capable of executing software. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) for storing software performing the operations discussed below, and random access memory (RAM) for storing results. Very large scale integration (VLSI), field-programmable gate array (FPGA), and application specific integrated circuit (ASIC) hardware embodiments may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits.

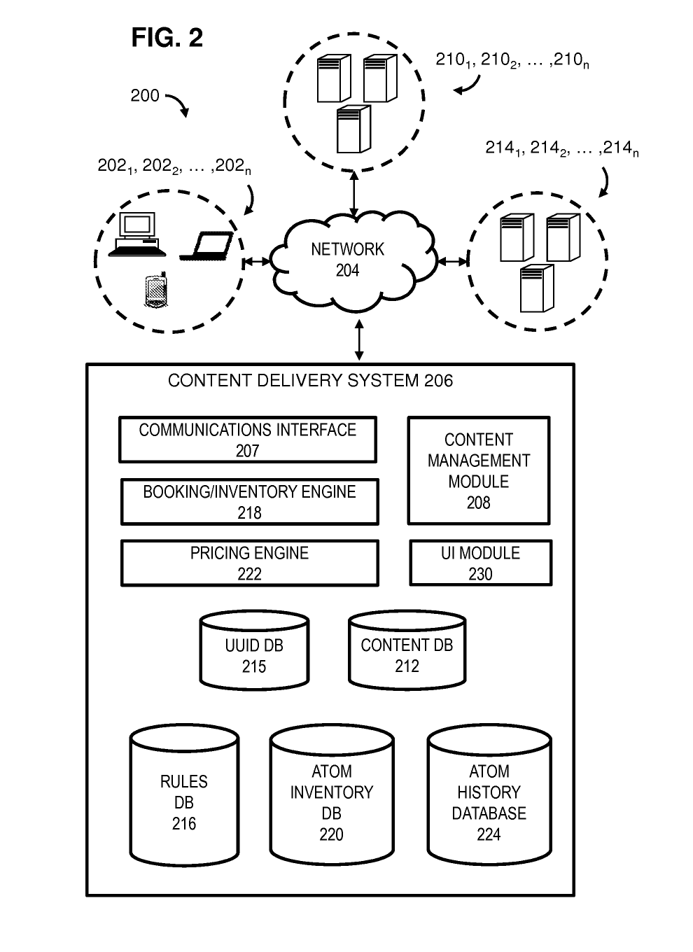

The present system and method is particularly useful for managing an inventory of atoms from one or more primary content providers for use by multiple content providers. A system 200 is illustrated in FIG. 2 wherein electronic devices communicate via a network for purposes of exchanging content and other data. In some embodiments, the present system and method are carried out on a local area network such as that illustrated in FIG. 2. However, the present principles are applicable to a wide variety of network configurations that facilitate the intercommunication of electronic devices.

In system 200, content packages are delivered to user terminals 202₁ . . . 202ₙ (collectively “202”) connected to a network 204 by direct and/or indirect communications with a content delivery system 206. In particular, the content delivery system 206 receives a request for an electronic content, such as a web page, from one of user terminals 202. Thereafter, the content delivery system 206 assembles a content package in response to the request and transmits the assembled content package to the requesting one of user terminals 202. The content in the assembled content package can include text, graphics, audio, video, or any combination thereof. Further, the assembled content packages can include content designed to elicit a pre-defined response from the user and that can vary over time. For example, the assembled content package can include one or more type of advertisements from one or more advertisers. The content delivery system can include a communications interface 207 to facilitate communications with the user terminals 202 and any other components in system 200.

The content delivery system 206 includes a content management module 208 that facilitates generation of the assembled content package that includes time-varying content, such as an advertisement. Specifically, the content management module can combine content from one or more one or more primary content providers 210₁ . . . 210ₙ (collectively “210”) and content from one or more secondary content providers 214₁ . . . 214ₙ (collectively “214”) to generate the assembled content package for the user terminals 202. For example, in the case of a web page being delivered to a requesting one of user terminals 202, the content management module 208 can assemble a content package by requesting the data for the web page from one of the primary content providers 210 maintaining the web page. For the time varying content on the web page provided by the secondary content providers 214, the content management module 208 can request the appropriate data according to the arrangement between the primary and secondary content providers 210 and 214.

Although, primary and secondary providers 210, 214 are presented herein as separate entities, this is for illustrative purposes only. In some cases, the primary and secondary providers 210, 214 can be the same entity. Thus, a single entity may define and provide both the static and the time-varying content.

In some embodiments, the content management module 208 can be configured to request that the data be sent directly from content providers 210 and 214, a cached arrangement can also be used to improve performance of the content delivery system 206 and improve overall user experience. That is, the content delivery system 206 can include a content database 212 for locally storing or caching content maintained by content providers 210 and 214. The data in the content database 212 can be refreshed or updated on a regular basis to ensure that the content in the database 212 is up to date at the time of a request from a user terminal. However, in some cases, the content management module 208 can be configured to retrieve data directly from content providers 210 and 214 if the metadata associated with the data in content database 212 appears to be outdated or corrupted.

In the various embodiments, the one or more databases described herein can be implemented any type of data structures. Such data structures include, but are not limited to data structures for relational databases, key/value stores, graph databases, hierarchical databases, and distributed or columnar stores. Accordingly, although the various embodiments described herein may refer to specific data structures in some embodiments, in other embodiments such data structures can be substituted for any other type of database structure.

In the various embodiments, the content delivery 206 can also include a unique user identifier (UUID) database 215 that can be used for managing sessions with the various user terminal devices 202. The UUID database 215 can be used with a variety of session management techniques. For example, the content delivery system 206 can implement an HTTP cookie or other conventional session management methods (e.g., IP address tracking, URL query strings, hidden form fields, window name tracking, authentication methods, and local shared objects) for user terminals 202 connected to content delivery system 206 via a substantially persistent network session. However, other methods can be used as well. For example, in the case of mobile devices or other types of user terminals connecting using multiple or non-persistent network sessions, multiple requests for content from such devices may be assigned to a same entry in the UUID database 215. Such an assignment can be provided by analyzing requesting device attributes in order to determine whether such requests can be attribute to a same device. Such attributes can include device or group-specific attributes.

As described above, content maintained by the content providers 210 and 214 can be combined according a predefined arrangement between the two content providers, which can be embodied as a set of rules. In an arrangement where the content delivery system assembles the content package from multiple content providers, these rules can be stored in a rules database 216 in content delivery system 206 and content management module 208 can be configured to assemble the content package for user terminals 202 based on these rules. The rules can specify how to select content from secondary content providers 214 and the primary content providers 210 in response to a request from one of user terminals 202. For example, in the case of a web page maintained by one of primary providers 210 and including variable advertisement portions, the rules database 216 can specify rules for selecting one of the secondary providers 214. The rules can also specify how to select specific content from the selected one of secondary providers 214 to be combined with the content provided by one of primary providers 210. Once assembled, the assembled content package can be sent to a requesting one of user terminals. However, the content package is not limited to the content from content providers 210 and 214. Rather, the content package can include other data generated at the content delivery system 206.

In many systems, the number and type of providers 210 and 214 are not static. For example, the number of primary content providers 210 and the amount and type of space they provide for second content providers 214 can vary over time. Further, the types of user and user terminals associated with the primary content providers 210 can also vary over time. Additionally, a similar variation in secondary content providers 214 can occur. That is, the number of secondary content providers 210 can vary over time, as well as the amount and types of space they require from primary content providers 214. Further, the types of user and user terminals of interest to the secondary content providers 210 can also vary over time. As a result, directly specifying and/or adjusting arrangements between the content providers 210 and 214 can quickly become complicated in such a dynamic environment.

The various embodiments therefore provide systems and methods for managing electronic advertising space in such a dynamic environments. In particular, an inventory atom-based booking and atom-based pricing system is provided. In particular the content space provided by primary content providers 210 is managed as an inventory or collection of atoms defining an inventory space or region in a k-dimensional space of atoms, where each of the k dimensions is associated with one of a plurality of traffic segment characteristics. In the various embodiments, the k dimensions can include both orthogonal and non-orthogonal dimensions. That is, some of the k dimensions can overlap or can be related in some aspect. For example, if separate dimensions are specified for city and state, these dimensions are non-orthogonal.

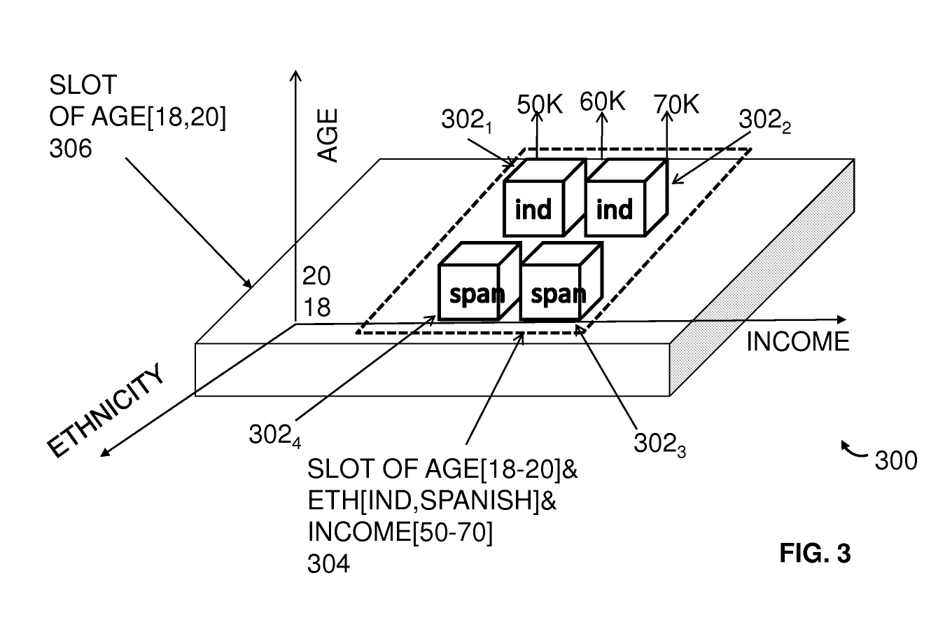

In the various embodiments, each atom represents a portion of traffic associated with a specific set of values for the traffic segment characteristics in the k-dimensional space. For example, an atom can represent a fixed number of impressions for a particular segment. The inventory space will consist of one or more portions of the k-dimensional space depending on the segment characteristics associated with the content space available from the primary content providers 210. Accordingly the content delivery system 206 can manage an electronic campaign for one or more secondary content provider 214 based on the one or more segment characteristics of interest to each of the secondary content providers 214. This is conceptually illustrated in FIG. 3.

FIG. 3 is a schematic diagram of an inventory space 300. As shown in FIG. 3, the space 300 is defined by demographic characteristics, specifically age, income, and ethnicity. Thus, each atom in space 300 is associated with an amount of traffic, a specific ethnicity, a specific age or age group, and a specific income or income group. For example, each of atoms 302₁, 302₂, 302₃, and 302₄ (collectively 302) is an amount of traffic (e.g., n impressions) associated with one of a Spanish or Indian ethnicity, one of a $50,000-$60,000 or a $60,000-$70,000 income bracket, an age range between 18 and 20. Thus, one of secondary content providers 210 wishing to deliver n impressions to Spanish and Indian users aged between 18 and 20 and having an income between $50,000 and $70,000, would request to reserve or book a slot 304 consisting of atoms 302. However, a larger slot of atoms could also be specified, such as slot 306 consisting of all atoms associated with users aged 18-20.

Although the space 300 in FIG. 3 is defined in terms of a few demographic segment characteristics, other segment characteristics can also be used. For example, an inventory space can include channel characteristics, spatial-temporal characteristics, behavioral characteristics, and demographic characteristics, to name a few. Channel characteristics can define the specific delivery channel being used to deliver a content package. For example, channel characteristics can include a type of electronic content, a type of device or user terminal, a carrier or network provider, or any other characteristic that defines a specific delivery channel for the content. Spatial-temporal characteristics can define a location, a date, a time, or any other characteristic that defines a geographic location and/or a time for delivery of the content. Demographic characteristics can define characteristics of the users targeted by the content or associated with the content. For example, demographic characteristics can include age, income, and ethnicity, as shown in FIG. 3, but can also include other demographic characteristics such as gender, occupation, or any other user characteristics. Behavioral characteristics can define user behaviors for one or more different types of content, separately or in combination with any other contextual characteristics. That is, different behavioral characteristics may be associated with different channel, demographic, or spatial temporal characteristics. For example, users may be associated with higher conversion or response rates for some types of delivery channels.

In FIG. 3, the atoms 302 are shown as defining the entire traffic for each combination of segment characteristics for purposes of illustration only. In the various embodiments, any number of atoms, each defining an amount of traffic, can be specified for each combination of segment characteristics. For example, referring to the example in FIG. 3 above, each of atoms 302 can represent a collection of m sub-atoms, such that each of the m sub-atoms represents an amount of the total traffic for the combination of segment characteristics. In the case of the n impressions described above for atoms 302, the m sub-atoms for each of atoms 302 can be each associated with an amount of n/m impressions. Alternatively, the atoms 302 can managed as being partially booked. In such configurations, as inventory slots are fulfilled, the metadata indicates each of the inventory slots it is associated with and the amount of traffic for each of the slots.

In FIG. 3, the inventory space 300 is shown as being continuous. However, in the various embodiments, an inventory space of inventory atoms can be continuous or discontinuous. For example, if a first primary content provider is associated with users with incomes between $25,000 and $50,000, a second primary content provider is associated with users with incomes between $70,000 and $100,000, and no other primary content providers are available, then the inventory space defined by these two primary content providers would exclude any atom associated with incomes between $50,000 and $70,000. As a result, the inventory space would be discontinuous. Although the above example discusses a single segment characteristic causing the discontinuity, in the various embodiments any number of segment characteristics can cause discontinuities in the inventory space.

It is also worth noting that although the above-mentioned examples are described in terms of the inventory atoms associated with the primary content providers 210, the inventory atoms defining the inventory space can be based on segment characteristics associated with other components or elements of system 200. For example, the primary content providers can have content and/or content space associated with segment characteristics in multiple dimensions and thus defines a first set of dimensions and segment characteristic values therein for the inventory space. However, the users and user terminal, based on their characteristics and behavior, can also be associated with segment characteristics in multiple dimensions. Thus, a second set of dimensions and values therein for the inventory space can be defined. Additionally, the content delivery system may be configured to consider with specific segment characteristics along multiple dimensions for the secondary content providers. Thus, a third set of dimensions and values therein for the inventory space can be defined. As a result, the inventory space is therefore defined by the atoms at the intersection of these different sets of dimensions and the values.

Referring back to FIG. 2, the content delivery system 206 can include a booking/pricing engine 218 that accesses an atom inventory database 220 to manage such requests. The atom inventory database 220 can be constructed by maintaining a list of atoms from each of the primary content providers 210 and associated metadata. Thus, for each atom, the associated metadata can specify a source of the atom (e.g., the associated primary content provider) and any other segment characteristics associated with the atom. For example, the associated metadata can specify a status of the atom (i.e., available, unavailable, or amount of traffic available), a secondary content provider who has already booked traffic of the atom, and other information related to the request that resulted in booking of traffic of the atom, such as the request associated with the booking of the slot. In some embodiments, the atom inventory database 220 can be organized in a tree-type structure. That is, each dimension is used to define a level of the tree structure. For example, in a tree structure based on the target user terminals, a root level can be split off into one or more manufacturers. The manufacturers can then be split off by model or family. The models or families can then be further split off in a similar manner until a final level, which specifies the atom and the atom metadata is reached.

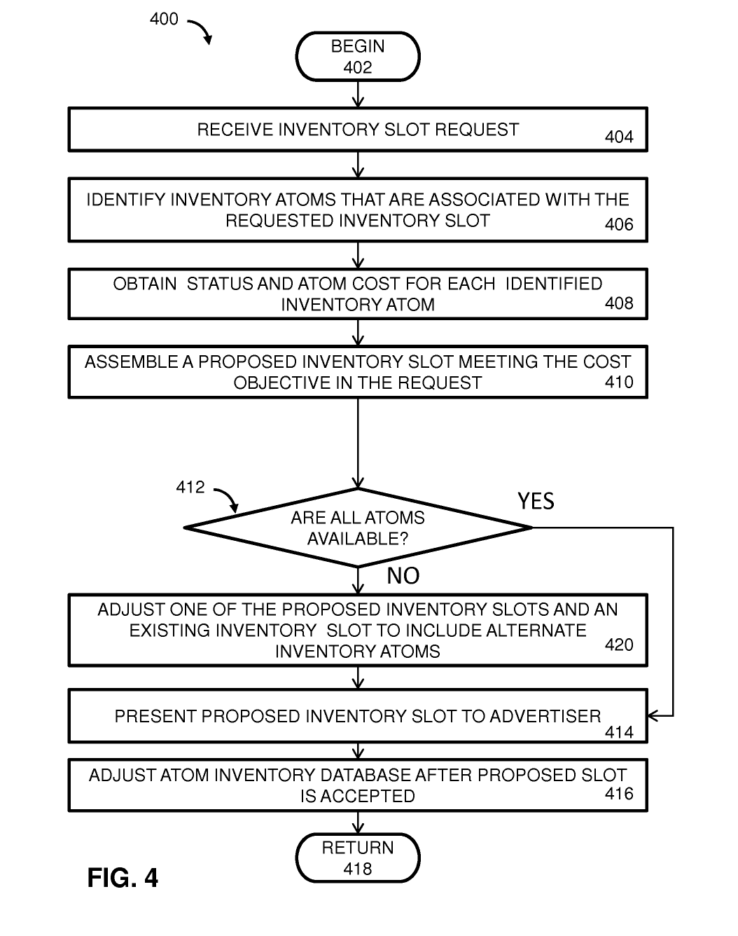

A booking operation in system 200 generally works as follows. First, booking/inventory engine 218 is forwarded a request for a target inventory slot received at the content delivery system 206. As described above, the request defines the desired slot, i.e. segment characteristics, and a cost objective for the target slot. In response to this request, the booking/inventory engine 218 finds the atoms associated with the request and retrieves an availability of each atom. Additionally, a cost for the traffic requested in each atom in the target inventory slot is also obtained. The traffic costs can be stored in atom inventory database 220 or calculated using a pricing engine 222 and an atom history database 224, as described in further detail below. Thereafter, the content delivery system will assemble a proposed inventory slot for the advertiser, defining the atoms that meet the advertiser's cost objective and the total cost for the proposed inventory slot. If the proposed slot is accepted, booking/inventory engine 218 can update the atom inventory database 220 to reflect the booking. This process is described below in greater detail with respect to FIG. 4.

FIG. 4 is a flowchart of steps in an exemplary method 400 for managing inventory atoms. Method 400 begins at step 402 and continues to step 404. At step 404, an inventory slot request is received. For example, an inventory slot request can be received from one of secondary providers 210 at content delivery system 206. Alternatively, a request can be received from other components in system 200. For example, a request can be received from one of user terminals 202, a user interface of content delivery system 206, a user interface of content providers 210 and 214, or at any other point in system 200. In the various embodiments, the inventory slot requests includes at least one segment characteristic of interest to the secondary provider 210. For example, as described above with respect to FIG. 3, the exemplary request therein specified an age range, an income range, and/or ethic groups of interest.

Additionally, the request can also specify a target objective for the slot. The objective can be expressed in several ways. For example, the request can simply specific a maximum budget not to be exceeded. In another example, the request can specify a mean or median value for the atoms to be included in the booked slot. In yet another example, the request can specify a budget that varies based on one or more segment characteristics. That is, different cost objectives can be specified for atoms associated with different segment characteristics. Additionally, other types of cost objectives can also be used. For example, these can include performance metrics, such as a minimum click-through rate (CTR), an effective cost per thousand impressions (eCPM), a target conversion rate, and a target fill rate, to name a few.

Furthermore, the request can also specify match criteria for the segment characteristics in the request. That is, for at least one of the segment characteristics in the request, the request can also include acceptable variations in the segment characteristics. For example, the request can specify a segment characteristic specifying a location in the city of San Francisco and match criteria specifying any location in northern California. Such match criteria can be subsequently used to provide alternative atoms in response to a request, as described in further detail below.

Once the request is received by the content delivery system 206 at step 404, the request is forwarded to the booking/inventory (B/I) engine 218 for subsequent processing at step 406. At step 406, the B/I engine 218 identifies the atoms in the atom inventory database associated with the target inventory slot. The identification of the atoms can be performed in several ways, depending on the data structure of the atom inventory database 220. For example, a lookup operation can be used for table-based database and a tree scanning operation can be used for tree-type database. However, any other methods can be used.

For example, in some embodiments, a Locality Sensitive Hashing (LSH) technique can be used in conjunction with forecasting techniques to generate the inventory of available atoms in the atom inventory database. In such a technique, a data preparation step is provided in which the data is first filtered for the contextual characteristics of interest, such as a specific date or dates. The filtered data consists of performance data for previously delivered content with respect to various contexts or segments, metadata for the content, and information identifying the request. Thereafter the impressions for a given atom are serialized based on the date(s). Following the data preparation, super atoms are created by using an LSH from the filtered atoms. The super cells are a mapping from the existing inventory space to a similar space preserving the isomorphic properties of their topological space. That is, a homomorphic mapping done with an intent to reduce dimensionality and also compute stable estimations. These two topological spaces are termed equivalent, and hence has a continuous function with a continuous inverse. The LSH hashing used here can be selected to limit the amount of computational complexity yet still provide an adequate data set for projecting information back to the original inventory atoms. Further, the aggregation of cells (done by hashing) is selected to limit the over averaging and hence cause incorrect estimation. The LSH is applied only on dimensions which has ordinal values in it.

In many cases, the factor affecting the dimensionality of atoms for a mobile device, such as a mobile telephone, is geographic information. For example, such geographic information can include a home location and a current location. In such cases, a hashing is provided to map a current location into its corresponding DMA and use it as the hash for the geographic dimension(s). Thus, the dimensionality and the stability of the estimation can be evaluated by first applying LSH on the geographic dimension. Further aggregation is then provided only if required. This method is not limited to geographic information. Other cardinal dimensions on which LSH can be used to identify super atoms include hour of day, income group, day of week, and content rating.

The aggregated impressions for super cells can then be temporally serialized. That is, the temporal data is modeled as the regressor and the actual inventory is modeled as regressand. A design matrix can then be computed with the above-mentioned model with beta parameters as the effects or regression coefficients. The design matrix from the given dates and the actual impression are the values to be estimated. If it is assumed that the data is homoscedastic, and the variance is independent of any parameter, ordinary least squares methods can then be used to compute the effects. Thereafter, forecasting is performed by applying the date values to a matrix equation consisting of the design matrix and the effects. Thus, values are estimated that indicate an inventory for the super atoms. Finally, the estimated values are mapped back from its current topological space to its original space. That is, the forecast information associated with the super atoms is projected back the atoms in the inventory space. Such information can be projected in a variety of ways. For example, in some embodiments an equal or weighted proportion distribution strategy can be used. That is, the information is projected back according to the proportional distribution of the original atoms in the super atoms.

Although the LSH method described above provides an estimate of available traffic for the inventory atoms, an update step can be required prior to identification of available atoms at step 408. In particular, since the inventory space and the status of the inventory atoms therein can change dynamically, the status of the inventory atoms updated using existing campaign information. That is, the status of the inventory atoms can be checked versus the current commitments for inventory atoms. Accordingly, those inventory atoms, or portions thereof, already associated with existing campaigns are marked as being unavailable. Thereafter, this updated inventory can then be used for booking inventory slots.

Afterwards or concurrently with the identification of atoms at step 406, a cost and a status of the identified atoms can be obtained. A status of the identified atoms can be obtained from the status metadata associated with the identified atoms in the atom inventory database. This status data can include the current availability (e.g., available traffic) of the atom. However, the status information retrieved can also include other metadata. For example, the status data for unavailable or booked atoms can also include data identifying the slot and/or the request associated with the previous booking of these atoms. In another example, the metadata can include data associated with a past performance, such as a past click-through rate (CTR), an effective cost per thousand impressions (eCPM), a conversion rate, and a fill rate, to name a few.

A cost for booking the identified atoms can also be obtained in several ways. For some atoms, a rate card or table can be used to determine the cost. That is, a particular atom or a particular amount of traffic for an atom can be associated with a fixed cost. Thus, the cost can also be stored as part of the metadata in the atom inventory database 220 and can be retrieved along the status information. In other instances, atoms and/or atom traffic can be associated with a fixed base cost that is adjusted based on the segment characteristics. For example, a single base cost can be associated with a collection of atoms. However, an adjustment to the cost can be specified for at least some of these atoms. For example, an adjustment can be specified that increases the cost of atoms associated with more popular or desirable segment characteristics. Similarly, for atoms associated with unpopular or undesirable segment characteristics, an adjustment can be specified that decreases the cost of these atoms. Such adjustments can be determined a priori. However, such adjustments can be determined dynamically during operation of system 200. That is, new costs for atoms can be determined in real-time as a function of varying supply and demand for atoms and inventory slots, changes in content providers, and budgets.

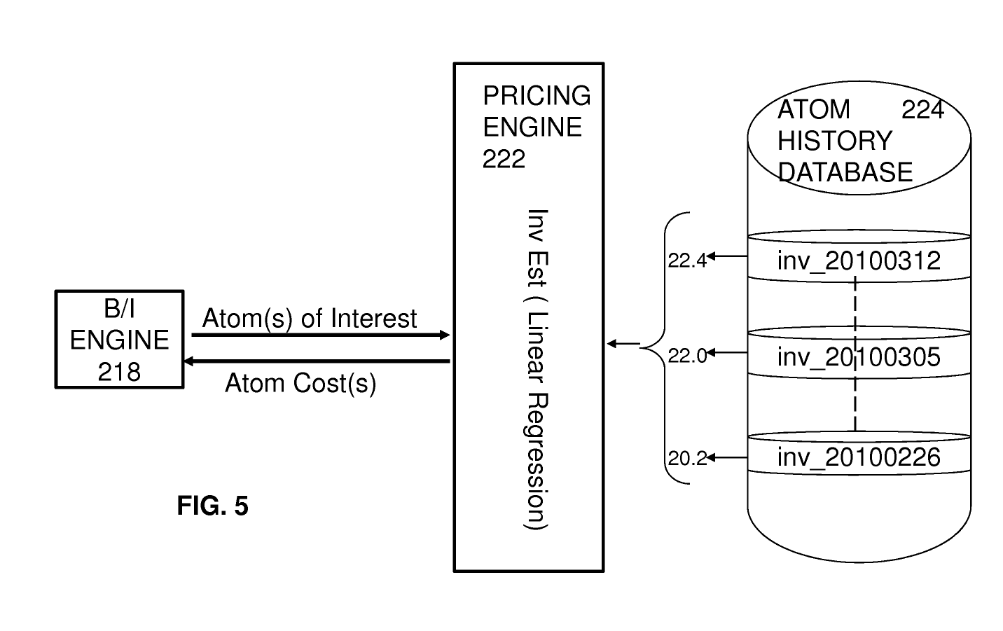

In some instances, the costs associated with atoms can be market driven. That is, the performance history for the atom can be retrieved (such as from an atom history database 222) and a future performance for the atom can be projected. This is conceptually illustrated in FIG. 5. FIG. 5 is a schematic of an exemplary process for estimating future demand and cost for an atom(s) of interest. First, a desired group of atoms or an inventory slot of interest is provided to the pricing engine 222 from the B/I engine 218. Thereafter, the pricing engine 222 retrieves the use history of such atoms from the atom history database 224. For example, the pricing engine 222 can obtain data indicating the number of impressions for the atom(s) of interest. Once the impression data is retrieved, a future demand (i.e., a projected number of impressions) can be projected. For example, as shown in FIG. 5, a linear regression technique can be used with a past number of impressions at different times to project a future number of impressions that are likely to be obtained at the date and time associated with the atom(s) of interest. However, the various embodiments are not limited in this regard, Accordingly, future demand can be projected based on other algorithms, such as neural network methods, fuzzy/probabilistic methods, Bayesian methods, or tree-based greedy algorithm methods, to name a few.

Based on this projected number of impressions, the pricing engine 222 can then compute costs associated with booking the atom. Thus, if a higher number of impressions are expected, a lower cost can be provided, as a large supply of impressions is available. In contrast, if a lower number of impressions are expected, indicating a smaller supply of impressions, a higher cost can be provided. In some embodiments, a combination of fixed and market driven methods can be used to obtain costs for booking atoms. For example, while the base cost is fixed, an adjustment cost can be based on a projection of performance and/or demand.

As described above, one method of determining the number of inventory atoms available is to also use a projection-type method. Accordingly, in some embodiments, a projection can be used for both projecting the amount of available inventory and to determine atom costs.

Referring back to FIG. 4, once the status and associated costs for booking each inventory atom are obtained at step 408, a proposed inventory slot can be generated in response to the request at step 410. In particular, a collection of the atoms identified in step 406 can be assembled that meet the cost objective in the request. For example, if the cost objective specifies a mean or median atom cost for as the cost objective, the resulting proposed inventory slot can be assembled by selecting a set of the identified inventory atoms that provides a mean or median atom cost that meets the cost objective. In another example, if the cost objective is a specific cost or cost range, the proposed inventory slot can be assembled by selecting a set of the identified inventory atoms that each has a cost meeting the cost objective. Thus, a proposed inventory slot may or may not include all the identified atoms for the requested slot depending on the cost objective and/or performance objectives.

Ideally, if all the atoms are available at step 412, the proposed inventory slot assembled at step 410 can be presented to the advertiser at step 414. Subsequently, once such proposed slot is accepted, the atom inventory database 220 can be adjusted at step 416 to indicate the unavailability of the atoms in the accepted slot. The method can then resume previous processing at step 418, including repeating method 400.

In some embodiments, when the proposed inventory slot is presented to the advertiser at step 414, the atom inventory database 220 can be temporarily adjusted to indicate the unavailability of the atoms (or portions of the traffic therein) in the proposed inventory slot. Such a configuration prevents another request from another advertiser being fulfilled prior to review and acceptance of the proposed inventory slot by the first advertiser. For example, if an advertiser requests to book 1 MM impressions for males 18-24 in San Francisco Bay area, the portion of the traffic of the atoms associated 1 MM impressions for males 18-24 in San Francisco Bay area can be “booked on hold” for 48 hrs until the payment and final commitment is done. During this time, the available impressions for this particular atom combination and any overlapping dimensions are reduced at 1 MM impressions. For example, if the total available impressions prior to this hold for the atoms were 20 MM, the hold reduces the total available impressions for the atoms to 19 MM.

In some instances, the proposed inventory slot can have an expiration date or time for acceptance, after which the atoms are marked as available in the atom inventory database 220. Thus, if a hold period expires in the example described above, the 1 MM impressions are added back to the total number of available impressions for the atom combination. In other instances, as supply and demand of some or all of the inventory atoms in the proposed inventory slot changes, the price of the slot can also be adjusted prior to acceptance.

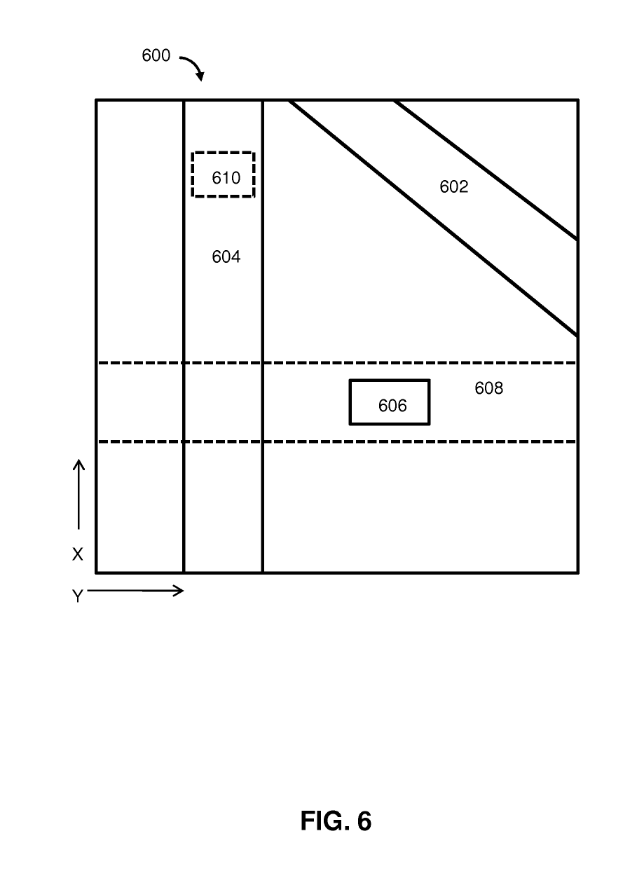

In some instances, it is possible that some of the atoms selected for the proposed inventory slot at step 410 will not be available (i.e., already booked for another slot) or will be only partially available (e.g., the remaining traffic in the atoms fails to meet the objective). For example, while the inventory atoms in a first portion of the proposed inventory slot may be fully available, inventory atoms in a second portion of the proposed inventory slot may be partially or completely unavailable. This is conceptually illustrated in FIG. 6. FIG. 6 is a schematic diagram showing possible conflicts or intersections between proposed and booked inventory slots in inventory space 600. Although an inventory space can include any number of dimensions associated with different segment or contextual characteristics, the inventory space 600 is shown as a two dimensional space with substantially rectangular slots for ease of illustration and explanation.

As shown in FIG. 6, inventory space 600 includes booked inventory slots 602, 604, and 606. FIG. 6 also shows proposed inventory slots 608 and 610. Ideally, to satisfy a request, it is desirable that the proposed slots not intersect or otherwise conflict with booked slots, such as in the case of slots 602 and slots 610 and 608. However, in some cases, the intersection or conflict may be unavoidable. For example, in the case of slot 604 and slot 608, the intersection of proposed slot 608 and slot 604 indicates that an entire portion of slot 608 along the Y dimension may be unavailable. That is, if insufficient traffic remains after slot 604 is booked, a conflict occurs. Similarly, the intersection of proposed slot 608 and slot 606 indicates that a portion of slot 608 along the Y dimension may be partially unavailable and the intersection of proposed slot 608 and slot 604 indicates the entire portion of slot 610 may be unavailable.

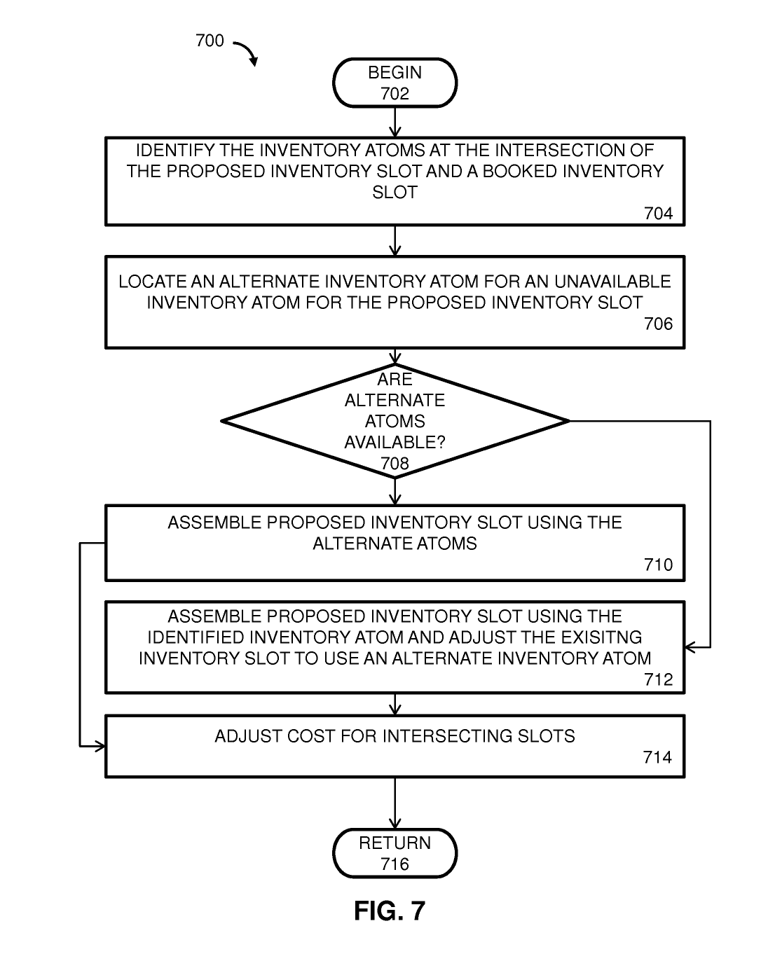

In the case of such conflicts, method 400 can instead proceed from step 412 to step 420. At step 420, the conflict between the proposed inventory slot and a booked slot(s) is resolved by adjusting one of these slots to utilize an alternate atom. This process is described below in greater detail with respect to FIG. 7. Thereafter, the proposed inventory slot (which may or may include alternate atoms) is presented to the advertiser at step 414. Once this proposed slot is accepted, the atom inventory database is adjusted at step 416 to indicate the unavailability of the atoms in the proposed slot plus the unavailability of any alternate atoms specified for the booked slots. Additionally metadata for these atoms can also be updated. The method can then resume previous processing at step 418, including repeating method 400.

As described above in FIG. 4, the various embodiments provide for removal of conflicts between slots by selecting alternate atoms to remove the conflict. An exemplary method for removing such conflicts is shown in FIG. 7. FIG. 7 is a flowchart of steps in an exemplary method 700 for removing conflicts between overlapping slots. Method 700 begins at step 702. At step 704, the atoms at the intersection of a proposed inventory slot and a booked inventory slot are identified. Such identification can be based on the segment characteristics for each slot. For example, a third slot can be identified, having both the segment characteristics of the booked slot and the proposed slot. These atoms therefore define the intersection between the slots. Alternatively, comparison methods can be used to identify common atoms. Other methods can also be used to identify the intersection.

Once the atoms for the intersection at identified at step 704, alternate atoms can be located for the proposed inventory slot at step 706. That is the B/I engine 218 can identify other atoms that are currently available and that can be substituted for the intersecting atoms. For example, if atoms we not previously selected because a maximum budget was already spent, available ones of those atoms can be used as alternate atoms for the proposed inventory slot. In another example, a request can include match criteria for one or more of the segment characteristics, as described above. Accordingly, available atoms that correspond to the match criteria can be used as alternate atoms for the proposed inventory slot. Thus, alternate atoms are located that match, at least partially, the segment characteristics in the original request.

In such embodiments, the B/I engine 218 can operate using a similarity/recommendation algorithm that analyzes the match criteria and recommends atoms meeting the match criteria and the target objective, when some of the inventory atoms in the proposed inventory slot are booked or otherwise unavailable. Additionally, when no match criteria are available, the similarity/recommendation algorithm can also be configured to instead recommend similar atoms (in terms of cost and performance objectives) atoms.

Depending on the amount of booked atoms in the space and the match criteria specified in a request, alternate atoms may or may not be located for intersecting atoms in a proposed inventory slot. If alternate atoms for the intersecting atoms of the proposed inventory slot are found at step 708, the proposed inventory slot is assembled using the alternate atoms at step 710. However, if alternate atoms are not available for the proposed inventory slot at step 708, method 700 proceeds to step 712. At step 712, for each intersecting atom of the proposed inventory slot not having an alternate atom, an alternate atom can instead be located for the booked inventory slot. Such atoms can be located in a similar manner as described above with respect to step 706. The proposed inventory slot can be assembled to include the intersecting atom in the proposed inventory slot and the booked slot can be modified to include an alternate atom once the proposed inventory slot is accepted.

Following either of steps 710 and 712, method 700 then proceeds to step 714. At step 714, a cost for the intersecting slots can be adjusted. That is, if alternate atoms are included in the proposed inventory slot or the booked inventory slot, an alternate price can be selected for such atoms. For example, a fixed discount can be provided. That is, the alternate atom is provided at the cost of the intersecting atom, but at a discounted price. However, in other cases, a discount may or may not be provided. For example, as described above, the cost for an atom can vary depending on several factors, such as the segment characteristics or a demand for the atom. Therefore, a combination of methods can be used to enhance revenue. For example, a fixed discount cost and an actual atom cost can be compared. A larger of the two costs can then be used for the alternate atom. In yet other cases, the cost for the intersecting atom can be adjusted. That is, since the intersection defines an increased demand for the atom, a premium cost can be associated with the atom. Thus, if such an atom is included in the proposed inventory slot, it cost can be increased. Once the adjustments at step 714 are completed, method 700 can proceed to step 716 and resume previous processing, including repeating method 700.

In the various embodiments, content delivery system 206 can be configured to permit users to adjust the operation and configuration of the various components of content delivery system 206. Accordingly, a user interface can be provided for communicating with a user interface (UI) module 230 for performing such tasks. Further, the UI module 230 can be configured to provide different levels of access based on authenticating different types of users. For example, administrative users can utilize the user interface and UI module 230 for specifying and/or modifying information regarding the primary content providers 210, the secondary content providers 214, user terminals 202, and end users. Administrative users can also utilize the user interface and UI module 230 for specifying operating parameters for the various interfaces, modules, engines, or databases of content delivery system 206. Further, administrative users can also utilize the user interface and UI module 230 for manually or directly adjusting any of the entries in the databases of content delivery system 206.

In addition to providing access to administrative users, the user interface and UI module 230 can also be configured to provide access to end users associated with primary content providers 210 and end users associated with secondary content providers. In the case of end users associated with primary content providers 210, the user interface and UI module 230 can be configured to allow such end users to, for example, update existing content from primary content providers 210 with the content delivery system 206, register new content or new primary content providers with the content delivery system 206, and/or specify preferences for selecting content from secondary content providers 214. In another example, the user interface and UI module 230 can include analysis tools for evaluating performance of content from the primary content providers 210, such as the performance of content with respect to the user terminals and/or content from the secondary content providers 214. In the case of end users associated with secondary content providers 214, the user interface and UI module 230 can be configured to allow these end users to, for example, update existing content from secondary content providers 214 with the content delivery system 206, register new content or new secondary content providers with the content delivery system 206, or specify preferences for selecting primary content providers 214. In another example, the user interface and UI module 230 can include analysis tools for evaluating performance of content from the secondary content providers 214, such as the performance of content with respect to the user terminals 202 and/or content from the primary content providers 210.

In the various embodiments, the user interface for the UI module 230 can be accessed via an end user terminal in communication with the content delivery system 206. For example, the end user terminal can be one of user terminals 202, a user interface device associated with any of content providers 210 and 214, or any user interface device or system locally or remotely connected to content delivery system 206. The user interface and UI module 230 can be configured to operate in a variety of client modes, including a fat client mode, a thin client mode, or a hybrid client mode, depending on the storage and processing capabilities of the content delivery system 206 and/or the end user terminal. Therefore, a user interface for UI module 230 can be implemented as a standalone application operating at the end user terminal in some embodiments. In other embodiments, web browser-based portal can also be used to provide the user interface for UI module 230. Any other configuration to remotely or locally accessing content delivery system 206 can also be used in the various embodiments.

Although the user interface and UI interface 230 are described above as providing specific types of functionality for specific types of end users, the user interface and UI module 230 can also be configured to allow other interactions between end users and the content delivery system 206. For example, the user interface and UI module 230 can be used to specify any of the parameters, weights, or any other variables for the systems and methods described herein. In another example, the user interface can also be user to view, analyze, and/or modify any final or intermediate results or data generated by any of the systems and methods described herein. In yet another example, the user interface and UI module 230 can also provide a reporting/analysis interface area designed for mining/analyzing performance of content from the secondary providers in terms of CTR, eCPM, cost measures, revenue measures, etc. Additionally, UI module 230 can be configured to sends notifications and alerts to users associated with primary content providers 210 (via email, messaging, etc.) when a campaign runs low, a budget runs low, or any other event of interest occurs. Additionally, the UI module 230 can also send daily/weekly/monthly reports of campaign delivery performance and suggestions for optimization to the content providers 210 and 214.

In one exemplary configuration, the user interface and the UI module 230 can be configured to provide administrative users and/or end users the ability to manipulate, select, and customize inventory atoms into groupings. Further, the user interface and the UI module 230 can allow such users to save these groupings with a custom name and/or book such groupings of inventory atoms. In such a configuration, the user interface can provides a series of selection objects (e.g., drop down boxes) for each dimension of interest. In some cases, these selection objects can be linked. For example, if a country is selected in one drop down box, a state drop down box automatically filters the drop down values to only country-specific states, and so forth. Additionally, as selections are made, the user interface can provide a region with a visual representation of inventory availability (e.g., a pie chart, and/or histogram). In some configurations, this region can present past, present, and future availability. Further, the region can also be adjusted to show the period of time of interest (e.g., 3, 6, 9, or 12 months). The user interface can also include a portion for end users to input their fixed parameters (e.g., budget, performance/cost objectives, time length of campaign, etc). These parameters can be used to further filter and update the visual representation of available inventory atoms as the user continues to select additional dimensions of interest (i.e., identify inventory slots of interest). The user interface can include a portion or area for temporarily reserving a proposed inventory slot or other proposed booking of inventory atoms for a limited period of the time (e.g., 24-48 hours).

In some configurations, a warning message can be provided to show the user that a demanded impressions volume may be much bigger than what is available. That is, when a requested inventory slot intersects with one or more booked inventory slots. In such cases, the user interface can be configured to provide a visual representation indicating the inventory atoms at issue. Further, the user interface can be configured to provide a visual representation that indicates alternative inventory atoms. In some cases, a visual representation of different combinations of alternative inventory atoms that fulfill the end user's demand can be generated and the user can be permitted to select from among the combination.

Other implementations according to these examples include computer-readable media for carrying or having computer-executable instructions or data structures stored thereon. Such computer-readable media can be any available media that can be accessed by a general purpose or special purpose computer. By way of example, and not limitation, such tangible computer-readable media can include RAM, ROM, EEPROM, CD-ROM or other optical disk storage, magnetic disk storage or other magnetic storage devices, or any other medium which can be used to carry or store desired program code means in the form of computer-executable instructions or data structures.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures that perform particular tasks or implement particular abstract data types. Computer-executable instructions, associated data structures, and program modules represent examples of the program code means for executing steps of the methods disclosed herein. The particular sequence of such executable instructions or associated data structures represent examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Communication at various stages of the described system can be performed through a local area network, a token ring network, the Internet, a corporate intranet, 802.11 series wireless signals, fiber-optic network, radio or microwave transmission, etc. Although the underlying communication technology may change, the fundamental principles described herein are still applicable.

The various embodiments described above are provided by way of illustration only and should not be construed as limiting. Those skilled in the art may recognize various modifications and changes that may be made while following the example embodiments and applications illustrated and described herein, and without departing from the true spirit and scope of the present disclosure.

1. A method, comprising:
receiving a request comprising a target inventory slot in an inventory space and a target objective;
identifying inventory atoms in an atom inventory database associated with the target inventory slot, a status of the identified inventory atoms, and an atom cost for the identified inventory atoms;
assembling a proposed inventory slot comprising at least a portion of the identified inventory atoms selected to meet the target objective;
responsive to at least one of the inventory atoms in the proposed slot being associated with at least one booked inventory slot, determining whether to adjust the inventory atoms for at least one of the proposed inventory slot and a previously booked inventory slot in the inventory space associated with the unavailable inventory atoms; and
generating a response to the request, the response comprising the proposed inventory slot.

2. The method of claim 1, wherein the target objective specifies a cost objective.

3. The method of claim 1, wherein the target objective specifies a performance objective.

4. The method of claim 1, wherein the target inventory slot is associated with a target time period, and wherein identifying the atom cost for one or more of the identified inventory atoms comprises:
obtaining a projection at least one of a performance and a demand for the one or more identified inventory atoms during the target time period based on a history of the one or more identified inventory atoms; and
estimating the atom cost based on the projection.

5. The method of claim 1, wherein identifying the atom cost for one or more of the identified inventory atoms further comprises retrieving a pre-defined cost as the atom cost.

6. The method of claim 1, wherein identifying the atom cost for one or more of the identified inventory atoms further comprises providing a base atom cost and adjusting the base atom cost based on one or more atom-specific factors.

7. The method of claim 1, wherein the step of adjusting further comprises selecting to adjust the inventory atoms of a one of the proposed inventory slot and the booked inventory slot associated with a lower priority.

8. A computer-readable medium having code for causing a computer to perform a method stored thereon, the method comprising:
receiving a request comprising a target inventory slot in an inventory space and a target objective, the target inventory slot specifying segment characteristics associated with a plurality of inventory atoms in an atom inventory database;
determining an atom cost for the plurality of inventory atoms based at least on a projection of demand or performance of the plurality of inventory atoms;
assembling a proposed inventory slot by selecting one or more inventory atoms from the plurality of inventory atoms to at least partially meet at least one traffic target of the target objective;
responsive to at least one of the inventory atoms in the proposed slot being failing to meet the one traffic target, adjusting the inventory atoms for at least one of the proposed inventory slot and a previously booked inventory slot in the inventory space associated with the unavailable inventory atoms; and
generating a response to the request, the response comprising the proposed inventory slot.

9. The computer readable medium of claim 8, wherein the request further comprises a target match criteria, and wherein the step of locating further comprises selecting the alternate inventory atoms for the unavailable selected inventory atoms to be an available inventory atoms from the atom inventory database meeting the target match criteria.

10. The computer readable medium of claim 9, wherein the target match criteria specifies a range of values for at least one of the segment characteristics.

11. The computer readable medium of claim 9, wherein the target match criteria specifies at least one alternate value for at least one of the segment characteristics.

12. The computer readable medium of claim 8, wherein determining the atom cost further comprises:
accessing a history of the plurality of inventory atoms;
generating a model of the demand or the performance of the plurality of inventory atoms based on the history;
computing the demand or the performance for a time period associated with the target inventory slot based on the model.

13. The computer readable medium of claim 12, wherein the model comprises a linear regression model.

14. The computer readable medium of claim 8, wherein the generating comprises computing an atom cost for the alternate inventory atoms based at least on the atom cost for the unavailable selected inventory atoms.

15. The computer readable medium of claim 14, wherein computing the atom cost for the alternate inventory atom comprises applying a discount to the atom cost for the unavailable one of the target inventory atoms.

16. The computer readable medium of claim 14, wherein computing the atom cost for the alternate inventory atoms comprises:
determining a first atom cost for the alternate inventory atoms based at least on a projection of demand or performance for the alternate inventory atoms;
determining a second atom cost for the alternate inventory atoms based on the atom cost for the unavailable selected inventory atoms; and
selecting the atom cost for each of the alternate inventory atoms to be the larger of the first and second atom costs.

17. A system comprising:
a communications interface for receiving requests comprising a target inventory slot in an inventory space and a target objective; a storage element for storing an atom inventory database of inventory atoms, the atom inventory database specifying a status of the inventory atoms and booked inventory slots associated with the inventory atoms; and
a processing element configured for:
identifying inventory atoms in the atom inventory database associated with the target inventory slot of a new request;
assembling a proposed inventory slot comprising at least a portion of the identified inventory atoms selected to meet the target objective;
responsive to at least one of the inventory atoms in the proposed slot being associated with at least one booked inventory slot, adjusting the inventory atoms for at least one of the proposed inventory slot and a previously booked inventory slot in the inventory space associated with the unavailable inventory atoms; and
causing the communications interface to generate a response to the request comprising the proposed inventory slot and the slot cost.

18. The system of claim 17, wherein during the selecting the processing element is further configured for selecting the alternate inventory atom for the proposed inventory slot if one of the identified inventory atoms is available.

19. The system of claim 17, wherein during the selecting the processing element is further configured for selecting the alternate inventory atom for the proposed inventory slot if one of the inventory atoms in the atom inventory database is available and meets the target match criteria.

20. The system of claim 17, wherein the processing element is further configured for identifying inventory atoms by determining a number of impressions available for the inventory atoms associated with the target inventory slot and computing the atom cost based on the available number of impressions.

21. The system of claim 17, wherein the processing element is further configured for identifying inventory atoms by:
forecasting an availability of the inventory atoms associated with the target inventory slot based on a past usage of the inventory atoms associated with the target inventory slot; and
selecting the identified inventory atoms to comprise the available inventory atoms based on the forecasting, exclusive of inventory atoms associated with the booked inventory slots for a current period of time.
